(19) United States
(12) Patent Application Publication
(10) Pub. No.: US 2026/0061854 A1
(43) Pub. Date: Mar. 5, 2026

(54) METHOD FOR OPERATING AN ELECTRIC MACHINE, CONTROL DEVICE, INVERTER CIRCUIT, STATOR, ELECTRIC MACHINE AND MOTOR VEHICLE

(71) Applicant: AUDI AG, Ingolstadt (DE)

(72) Inventor: Daniel RUPPERT, Lenting (DE)

(21) Appl. No.: 19/313,303

(22) Filed: Aug. 28, 2025

(30) Foreign Application Priority Data
Aug. 29, 2024 (DE) 102024124736.3

(51) Int. Cl. B60L 15/20; H01F 38/18; H02K 11/33; H02M 7/5387

(52) U.S. Cl. CPC B60L 15/20; H01F 38/18; H02K 11/33; H02M 7/53871; B60L 2210/42; B60L 2240/526

(57) ABSTRACT

A method for operating an electric machine that includes a stator and a rotor rotatably mounted with respect to the stator, wherein an inverter circuit that is provided on the stator converts a direct voltage of a voltage source into an alternating voltage output to a stator-side transfer coil, wherein the inverter circuit includes a full bridge circuit which is connected to the voltage source via a half bridge circuit, and is connected to the stator-side transfer coil, wherein control signals for controlling transistors of the half bridge circuit and the full bridge circuit are generated and output by a control device, to cause the inverter circuit to be operated in a full bridge operating mode in which the direct voltage is completely converted into the alternating voltage, or in a half bridge operating mode in which the direct voltage is only partially converted into the alternating voltage.

### BACKGROUND

### Technical Field

The present disclosure relates to a method for operating an electric machine of a motor vehicle, wherein the electric machine comprises a stator and a rotor rotatably mounted with respect to the stator and having rotor windings for generating a rotor magnetic field, wherein an inverter circuit is provided on the part of the stator by way of which inverter circuit the direct voltage of a voltage source is converted into an alternating voltage and output to at least one stator-side transfer coil, wherein power is transferred inductively to the rotor by way of the stator-side transfer coil for energizing the rotor windings.

### Description of the Related Art

Electric machines are often used as traction motors in motor vehicles, which can be purely electric vehicles or hybrid vehicles. Electric machines comprise a stator and a rotor rotatably mounted with respect to the stator, wherein windings consisting of a conductor wire and, if appropriate, permanent magnets are provided on the part of the stator and the rotor, wherein electromagnetic interactions between the magnetic fields generated by the windings and, if appropriate, the permanent magnets bring about the generation of a drive or braking torque. If there are no windings on the part of the rotor but only permanent magnets, the machine is also referred to as a permanently excited synchronous machine. If there are no permanent magnets on the part of the rotor but only windings, which are referred to as rotor windings, the machine is referred to as an externally excited synchronous machine. Externally excited synchronous machines offer additional degrees of freedom in the context of the control and design of the electric machine.

The energy stored in the motor vehicle’s electrical energy storage device is utilized to operate the electric machine. Here, the electrical energy storage device provides a direct voltage, which must be converted into an alternating voltage on the stator side to enable inductive energy transfer to the rotor. For this purpose, on the part of the stator, the voltage source provided by or connected to the electrical energy storage device is connected to the inverter circuit. This inverter circuit converts the direct voltage present on the part of the voltage source into an alternating voltage. Similar concepts are known, for example, from DE 10 2020 119 598 A1, CN 1 14 285 285 A, and CN 1 11 817 449 A.

Particularly, since a wide range of values for the direct voltage present is conceivable on the part of the voltage source, for example, between 350 V and 920 V, the problem often arises that with high direct voltage values and low values of the power to be transferred from the stator to the rotor, only low effectiveness or a low efficiency can be achieved with regard to both inverting and power transfer. This is disadvantageous.

### BRIEF SUMMARY

The disclosure is based on the object to provide an improved concept for an electric machine with inductive power transfer from the stator to the rotor, in particular with regard to the highest possible efficiency.

According to the disclosure, the object is achieved in a method of the type mentioned above, in that the inverter circuit comprises a full bridge circuit which is connected, on the one hand, to the voltage source via a half bridge circuit and, on the other hand, to the at least one stator-side transfer coil, wherein control signals for controlling transistors of the half bridge circuit and the full bridge circuit are generated and output by way of a control device, so that the inverter circuit is operated in a full bridge operating mode in which the direct voltage present on the part of the voltage source is completely converted into the alternating voltage by way of the inverter circuit, or in a half bridge operating mode in which the direct voltage present on the part of the voltage source is only partially converted into the alternating voltage by way of the inverter circuit.

The disclosure is based in particular on the idea that in those cases where there is low effectiveness or low efficiency with respect to inverting and power transfer, this problem is overcome by operating the inverter circuit in the half bridge operating mode. Low effectiveness is to be expected, in particular, when there is a high value of the direct voltage on the part of the voltage source and a low value of the power to be transferred. To solve or circumvent this problem, only a portion of the direct voltage is converted into alternating voltage in the half bridge operating mode, which is accompanied by a significant increase in effectiveness or efficiency. Thus, in the context of the present disclosure, an active, i.e., controllable, inverter circuit is provided which is specifically brought into half bridge operating mode or full bridge operating mode by way of the appropriate control signals.

The electric machine can comprise a housing that is fixed to the body of the motor vehicle, with the stator components being permanently installed in the housing. The rotor can be connected to the stator or the housing via at least one pivot bearing, which can be a ball or roller bearing. For this purpose, a rotor shaft can be arranged on both sides and rotatably in one pivot bearing in each case.

The transfer coil can have or be a winding made of an electrically conductive wire, which is energized by the alternating voltage generated by the inverter circuit. In the transfer coil, an electromagnetic field is cyclically established and reduced, with the temporal variability of this field enabling the inductive power transfer to the coil.

According to the disclosure, the inverter circuit comprises the full bridge circuit and the half bridge circuit. A full bridge circuit has, based on the associated circuit diagram, an H-shape, with two series-connected transistors arranged in each of the two vertical branches of this circuit. The horizontal branch connecting the two vertical branches, is often also referred to as the bridge arm. The half bridge circuit comprises two series-connected transistors. The transistors are semiconductor structural components, preferably metal oxide semiconductor field effect transistors (MOSFETs for short) and/or insulated gate bipolar transistors (IGBTs for short). Thus, to control the circuit states of the transistors, a respective gate voltage must be applied to the respective transistor, in particular to place it into a conducting or blocking state.

The full bridge circuit preferably comprises two parallel-connected pairs of series-connected full bridge transistors in each case, with a coil node arranged between the full bridge transistors of each of the pairs, wherein the at least one stator-side transfer coil is connected between the two coil nodes. The full bridge transistors of each of the pairs can be connected to one another in such a way that a source terminal of the one full bridge transistor is connected to the drain terminal of the respective other full bridge transistor, with the coil node located therebetween. An electrical line leading to the transfer coil branches off from each of the coil nodes, so that the transfer coil is integrated into the bridge branch.

The half bridge circuit may comprise two series-connected half bridge transistors, with a half bridge node arranged between the full bridge transistors of one of the pairs, via which the half bridge circuit is coupled to the full bridge circuit. The half bridge transistors may be connected to one another in such a way that a source terminal of the one half bridge transistor is connected to the source terminal of the other half bridge transistor.

Preferably, the control signals for implementing the half bridge operating mode of the inverter circuit are generated by way of the control device in such a way that the half bridge transistors are permanently in a conducting state and the full bridge transistors, between which the half bridge node is arranged, are permanently in a non-conducting state. Thus, in the half bridge operating mode, only one pair comprising two full bridge transistors is utilized for inverting, so that only half of the generally available voltage is supplied to the stator-side transfer coil.

It is conceivable that the control signals for implementing the full bridge operating mode of the inverter circuit are generated by way of the control device in such a way that the half bridge transistors are permanently in a non-conductive state. In this case, in full bridge operating mode, both pairs, each comprising two full bridge transistors, are utilized for inverting, so that the entire generally available voltage is supplied to the stator-side transfer coil.

As already mentioned, the control signals provided for controlling the transistors are generated on the part of the control device. With respect to a respective control basis, it can be provided that the control signals are generated based on a piece of power information relating to a power currently to be transferred to the rotor by way of the stator-side transfer coil, and/or a piece of voltage information relating to the current direct voltage of the voltage source by way of the control device in such a way that the inverter circuit is in either the half bridge operating mode or the full bridge operating mode. The piece of power information can be or comprise a number indicating the value of the power currently to be transferred, for example, in watts. The piece of voltage information can be or comprise a number indicating the value of the current direct voltage, for example, in volts. The piece of power information and/or the piece of voltage information can be determined by sensors, i.e., by measurement. It is conceivable, additionally or alternatively, that control commands from a control unit provided for controlling the operation of the electric machine are provided, wherein the piece of power information and/or the piece of voltage information are/is determined based on the control commands. The control device may be or comprise the control unit.

It is preferably provided that the control signals are generated by way of the control device in such a way that the inverter circuit is in the half bridge operating mode when the piece of power information indicates that the power currently to be transferred is lower than a power limit value, and that the inverter circuit is in the full bridge operating mode when the piece of power information indicates that the power currently to be transferred is greater than the power limit. Thus, the power limit value provides a decision criterion with respect to the respective operation. Additionally or alternatively, it is conceivable that the control signals are generated by way of the control device in such a way that the inverter circuit is in the half bridge operating mode when the piece of voltage information indicates that the currently present direct voltage is lower than a voltage limit value, and that the inverter circuit is in the full bridge operating mode when the piece of voltage information indicates that the currently present direct voltage is greater than the voltage limit value. Thus, the voltage limit value provides a decision criterion for the respective operation. In this regard, it is also conceivable that the power limit value is a function of the voltage limit value, and/or vice versa.

In the context of a conceivable refinement, it is provided that there is a characteristic curve relating to the efficiency of the inverter circuit and/or relating to the efficiency of the power transfer from the stator to the rotor as a function of the power currently transferred for both the half bridge operating mode and the full bridge operating mode, wherein the value of the power currently to be transferred at which these characteristic curves intersect is used as the power limit value. Additionally or alternatively, it is conceivable that a characteristic curve relating to the efficiency of the inverter circuit and/or relating to the efficiency of the power transfer from the stator to the rotor as a function of the direct voltage currently present is present for both the half bridge operating mode and the full bridge operating mode, wherein the value of the direct voltage currently present at which these characteristic curves intersect is used as the voltage limit value. If only one of the two aforementioned alternatives is implemented, the characteristic curve is present as a characteristic line in which the resulting efficiency is a function of the power or the voltage. Particularly preferably, both alternatives are implemented so that the resulting efficiency is a function of these two quantities. In this case, this function is a three-dimensional relationship in which an associated value of the resulting efficiency is known for each pair of values relating to the power and the voltage. The characteristic curves can be stored, for example as a corresponding value or lookup table, on the part of a storage device, which can be a storage medium of the control device.

With respect to a specific check as to whether the half bridge operating mode or the full bridge operating mode is to be chosen, it is conceivable that the associated value of the resulting efficiency is determined for both modes based on the respective piece(s) of information regarding the power and/or the voltage, wherein the operating mode with the higher value of the resulting efficiency is selected.

Furthermore, the present disclosure relates to a control device. According to the disclosure, the object is achieved in such a control device in that it has a computer-readable storage medium on which instructions are stored which, when executed by way of the control device designed as a computer, cause a processing device of the control device to generate and output control signals which bring about the execution of at least one of the steps of the method according to the preceding description. All features, advantages and aspects explained in connection with the method according to the disclosure are equally transferable to the control device according to the disclosure, and vice versa.

It is conceivable that the control device according to the disclosure is set up to generate and output the control signals, which represent corresponding gate voltages, for example, for controlling transistors of the half bridge circuit and the full bridge circuit, so that the inverter circuit is operable in a low-voltage operating mode in which the voltage present on the part of the voltage source is applied entirely to the full bridge circuit, and in a full bridge operating mode in which the voltage present on the part of the voltage source is applied only partially to the full bridge circuit.

Furthermore, the present disclosure relates to an inverter circuit. According to the disclosure, the object is achieved in that the inverter circuit can be used in a method as described above, wherein the direct voltage of a voltage source can be converted into an alternating voltage and output to at least one stator-side transfer coil by way of the inverter circuit, wherein the inverter circuit comprises a full bridge circuit which is or can be connected, on the one hand, to the voltage source via a half bridge circuit and, on the other hand, to the at least one stator-side transfer coil. All features, advantages, and aspects explained in connection with the method according to the disclosure and the control device according to the disclosure are equally transferable to the inverter circuit according to the disclosure, and vice versa.

The present disclosure further relates to a stator for an electric machine for a motor vehicle. According to the disclosure, this object is achieved in that the stator comprises an inverter circuit according to the preceding section of the description. Preferably, the stator further comprises a control device according to the above sections of the description. Alternatively, the control device can be a component of the electric machine or the motor vehicle. All features, advantages, and aspects explained in connection with the method according to the disclosure, the control device according to the disclosure, and the inverter circuit according to the disclosure are equally transferable to the stator according to the disclosure, and vice versa.

Furthermore, the present disclosure relates to an electric machine for a motor vehicle. According to the disclosure, the object is achieved in such an electric machine in that it comprises a stator according to the preceding section of the description and a rotor rotatably mounted with respect to the stator and having rotor windings for generating a rotor magnetic field. All features, advantages, and aspects explained in connection with the method according to the disclosure, the control device according to the disclosure, the inverter circuit according to the disclosure, and the stator according to the disclosure are equally transferable to the electric machine according to the disclosure, and vice versa.

The electric machine preferably has an inductive rotary transformer, comprising at least one rotor-side transfer coil present on the part of the rotor, and the at least one stator-side transfer coil present on the part of the stator, wherein power can be transferred inductively to the at least one rotor-side transfer coil by way of the at least one stator-side transfer coil for energizing the rotor windings. The inductive rotary transformer enables contactless and thus low-wear or wear-free power transfer from the stator to the rotor. The rotor-side transfer coil and the stator-side transfer coil move past each other during the rotation of the rotor, wherein magnetic fields generated on the part of the stator-side transfer coil bring about the occurrence of a voltage on the part of the rotor-side transfer coil by way of electromagnetic induction. The rotor-side transfer coil thus functions as the voltage source, with the generated voltage being present as an alternating voltage. Preferably, a plurality of transfer coils are provided which are arranged concentrically about an axis of rotation of the rotor and thus along the circumferential direction.

It is conceivable that the at least one rotor-side transfer coil is connected to the rotor windings via a rectifier circuit, wherein the alternating voltage present on the part of the at least one rotor-side transfer coil can be converted into a direct voltage required to generate the rotor magnetic field by way of the rectifier circuit. The rectifier circuit preferably comprises electrical structural components, such as transistors. In this case, the rectifier circuit can be controlled by way of control signals generated, for example, by the control device, wherein the control signals can be directed to controlling the operation of the rectifier circuit, namely to carrying out rectification. Thus, the rectifier circuit is preferably an active rectifier circuit which, in contrast to passive rectifier circuits, has not only passive structural components such as semiconductor diodes, but also has controllable structural components such as transistors. The alternating voltage present on the output side of the rectifier circuit is supplied to the rotor windings to generate the rotor magnetic field.

A bidirectional power transfer can preferably be carried out by way of the rotary transformer. This enables de-excitation of the rotor windings, i.e., a reduction of the rotor magnetic field present on the part of the rotor windings, in that a direct voltage present on the part of the rotor windings is converted into an alternating voltage by way of the rectifier circuit, wherein the energy stored in the rotor windings is inductively transferred from the rotor-side transfer coil to the stator-side transfer coil. For this purpose, by way of appropriate control signals, the rectifier circuit is brought into a state in which the direct voltage present on the part of the rotor windings is converted into an alternating voltage, which in turn is applied to the rotor-side transfer coil. Accordingly, power is dissipated to the stator-side transfer coil, which in turn is supplied to the energy storage device of the motor vehicle via the inverter circuit, which in this case functions as a rectifier circuit.

Since the control device is typically located at a position different from the rotor, and, however, the control signals of control device are used also for controlling the rotor-side rectifier circuit, a transmission of these control commands from a stationary section of the electric machine, in particular the stator, to the rotor is required. For this purpose, the electric machine can have an inductive communication rotary transformer, which comprises at least one rotor-side communication coil present on the part of the rotor and at least one stator-side communication coil present on the part of the stator, wherein the control commands generated by the control device, which are used for the control operation of the rectifier circuit, are inductively transferrable from the stator-side communication coil to the rotor-side communication coil. The aspects explained above in connection with the inductive rotary transformer apply, generally equally and analogously to the communication rotary transformer.

Preferably, the electric machine according to the disclosure is connected or connectable to a drive train of the motor vehicle, wherein, in relation to the state connected to the drive train, a traction torque can be generated by way of the electric machine and transferred to the wheels of the motor vehicle via the drive train. For example, an open end of a rotor shaft of the rotor extending along the axis of rotation can be provided, in particular projecting from the housing of the electric machine. This end and a component of the drive train can each have a connecting means, such as a connecting flange, by way of which a mechanical connection, in particular a rotationally fixed mechanical connection, can be established between the shaft and the drive train. The drive train generally comprises all components via which a mechanical coupling can be established between the electric machine and the wheels. Thus, the drive train may comprise drive shafts and/or transmissions, in particular manual and/or differential transmissions and/or clutches.

Finally, the present disclosure relates to a motor vehicle comprising a traction motor. According to the disclosure, the object is achieved in such a motor vehicle in that the traction motor is an electric machine according to the preceding sections of the description. All features, advantages and aspects explained in connection with the method according to the disclosure, the control device according to the disclosure, the rectifier circuit according to the disclosure, the stator according to the disclosure and the electric machine according to the disclosure are equally transferable to the motor vehicle according to the disclosure, and vice versa.

The motor vehicle according to the disclosure preferably comprises an electrical energy storage device in which energy utilizable for the traction of the motor vehicle can be stored. This energy is present as electrical energy and is converted into kinetic energy by the electric machine. Conversely, it is conceivable to operate the electric machine in a recuperation mode, in which kinetic energy of the motor vehicle is converted into electrical energy, which is stored in the energy storage device. The direct voltage of the voltage source can be provided by way of the energy storage device, which, in particular, can be a lithium-ion battery.

### BRIEF DESCRIPTION OF THE SEVERAL VIEWS OF THE DRAWINGS

Further advantages and details of the present disclosure will become apparent from the following exemplary embodiments and from the accompanying figures. In the figures, schematically:

FIG. 1 shows a schematic diagram of a motor vehicle according to the disclosure, illustrated from the side, according to an exemplary embodiment, comprising an electric machine according to the disclosure according to an exemplary embodiment with a stator according to the disclosure according to an exemplary embodiment and a control device according to the disclosure according to an exemplary embodiment, wherein a method according to the disclosure according to an exemplary embodiment is explained based on this motor vehicle,

FIG. 2 shows a highly schematic, circuit diagram-like schematic diagram of the electric machine of the motor vehicle of FIG. 1,

FIG. 3 shows a section of the schematic diagram of FIG. 2, showing a rectifier circuit in a full bridge operating mode,

FIG. 4 shows a section of the schematic diagram of FIG. 2, showing a rectifier circuit in a half bridge operating mode, and

FIG. 5 shows a coordinate system to illustrate the relationship between efficiency and power.

### DETAILED DESCRIPTION

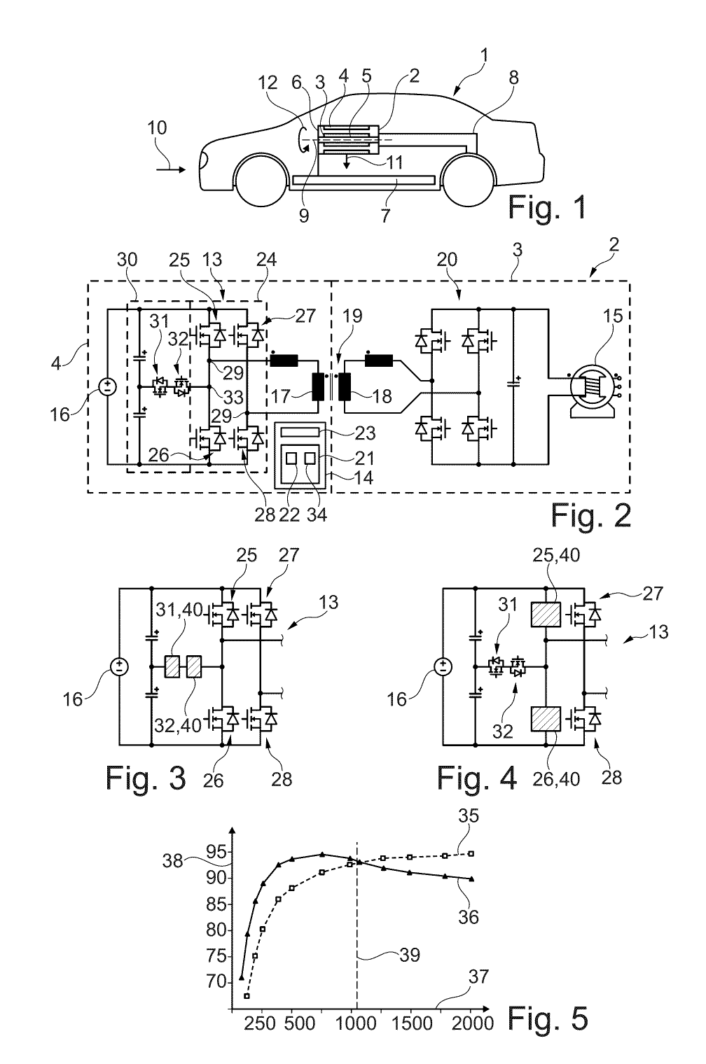

FIG. 1 shows a motor vehicle 1 according to the disclosure according to an exemplary embodiment, comprising a traction motor, which is an electric machine 2 according to the disclosure according to an exemplary embodiment. Electric machine 2 comprises a rotor 3 and a stator 4 according to the disclosure according to an exemplary embodiment. Electric machine 2 is an internal rotor designed as an externally excited synchronous machine. Thus, rotor 3 is arranged in a region of electric machine 2 that is radially further inward than a region in which stator 4 is arranged. A rotor shaft 5 of rotor 3 is rotatably mounted on a housing 6 of electric machine 2, for example by way of a ball or roller bearing.

Electric machine 2 is set up to be operated in a drive mode in which electrical energy stored in an electrical energy storage device 7 of motor vehicle 1 is converted into kinetic energy of motor vehicle 1. A generated drive torque, which is utilized to propel motor vehicle 1, is transferable from electric machine 2 to a drive train 8 of motor vehicle 1. The drive torque is only transferable to the rear wheels, but additionally or alternatively also transferable to the front wheels. Electric machine 2 can also be operated in a recuperation mode in which kinetic energy of motor vehicle 1 is converted into electrical energy by way of electric machine 2, which can be utilized, for example, to charge electrical energy storage device 7.

Definitions regarding relevant spatial directions are introduced below with reference to electric machine 2. For example, motor shaft 5 is rotatably mounted about an axis of rotation 9, which extends along a longitudinal direction 10 of electric machine 2. A radial direction 11 extends perpendicular to longitudinal direction 10. A circumferential direction 12 is perpendicular to radial direction 11. This means that a point rotating about axis of rotation 9 moves along circumferential direction 12.

Details regarding electric machine 2 are explained below. FIG. 2 shows a highly schematic, circuit diagram-like view of electric machine 2, which particularly illustrates the division of the components of electric machine 2 into rotor 3 and stator 4. Here, an inverter circuit 13 is provided on the part of stator 4, by way of which a direct voltage provided on the part of electrical energy storage device 7 to or via a voltage source 16 of electric machine 2 can be converted into an alternating voltage. In the present case, inverter circuit 13 comprises a printed circuit board on which electronic structural components of inverter circuit 13 are arranged, in particular soldered. To control the operation of the inverter circuit 13, a control device 14 according to the disclosure is provided according to an exemplary embodiment, which control device is set up to generate control signals, which control the operation of inverter circuit 13, or corresponding control voltages and to output them to inverter circuit 13. Although control device 14 is illustrated here as a component of electric machine 2, it can also be provided outside electric machine 2 and thus instead be a component of motor vehicle 1. The alternating voltage generated by way of inverter circuit 13 can be used to energize stator windings of stator 4 (not shown in detail in the figures) and rotor windings 15 of rotor 3, of which only one is indicated schematically in FIG. 2. The stator windings and rotor windings 15, each consisting of a conductor wire, generate magnetic fields due to the electrical energization, i.e., the rotor magnetic field and a stator magnetic field, which interact with each other during the generation of the drive or recuperation torque.

Now, details regarding the transfer of electrical energy or power from energy storage device 7 or voltage source 16 to stator windings 15 are explained. Here, first, the direct voltage provided by energy storage device 7 or present on the part of voltage source 16 is converted into an alternating voltage by way of rectifier circuit 13. This alternating voltage is transferred to a stator-side transfer coil 17 present on the part of stator 4, via which transfer coil 17 energy is transferred inductively to a rotor-side transfer coil 18 present on the part of rotor 3. Field coils 16, 17 form an inductive rotary transformer 19, via which a contactless energy transfer from stator 4 or a stationary section of electric machine 2 to rotor 3 is enabled.

Rotor-side field coil 18 implements a voltage source which is present on the part of rotor 3 and on the part of which an electrical alternating voltage is present. This alternating voltage is supplied to a rectifier circuit 20 of rotor 3, which converts this alternating voltage into a direct voltage. Rectifier 20 connects rotor-side transfer coil 18 to rotor windings 15, so that the voltage provided via rotor-side transfer coil 18 and converted into a direct voltage by way of rectifier circuit 20 is supplied to rotor windings 15 for generating the rotor magnetic field. Active rectifier circuit 20 comprises a plurality, namely four, transistors, which, for the sake of clarity, are not provided with a reference numeral in the figures and which, in this case, are metal oxide semiconductor field effect transistors. The rectification of the alternating voltage provided by rotor-side field coil 18 takes place based on control voltages generated on the part of control device 14, which are each applied to one of field effect transistors of rectifier circuit 20.

In addition to generating the control signals provided for inverter circuit 13, control device 14 is thus further set up to generate the previously mentioned control signals for controlling the operation of active rectifier circuit 20, and to output them to active rectifier circuit 20 via an inductive communication rotary transformer (not shown in detail). The communication rotary transformer comprises a stator-side communication coil present on the part of stator 4 and a rotor-side communication coil present on the part of rotor 3, wherein the control signals of control device 14 provided for the operation of 20 are transferred inductively from the stator-side communication coil to rotor-side communication coil and subsequently to transistors of rectifier circuit 20. The operating principle of communication rotary transformer is generally the same as that of rotary transformer 19.

To carry out a method according to the disclosure explained below according to an exemplary embodiment, control device 14 is set up to generate corresponding control signals directed toward carrying out this method. For this purpose, control device 14 comprises a computer-readable storage medium 21 on which executable instructions 22 are stored which, when executed by way of a processor or processing device 23 of control device 14, cause processing device 14 to carry out the steps provided in the context of the present method. Specifically, control signals are generated by way of control device 14 which are applied to transistors 25-28, 31, 32 of inverter circuit 13 as gate voltages. Respective connecting lines are not shown in the figures for the sake of clarity.

First, however, further details of inverter circuit 13 will be explained. In this case, it comprises a full bridge circuit 24, which in turn comprises two parallel-connected pairs of series-connected full bridge transistors 25-28 in each case. A coil node 29 is provided between full bridge transistors 25-28 of each pair, wherein stator-side transfer coil 17 is connected between the two coil nodes 29. Furthermore, inverter circuit 13 comprises a half bridge circuit 30 connected to full bridge circuit 24, which in turn comprises two series-connected half bridge transistors 31, 32. A half bridge node 33 is arranged between full bridge transistors 25, 26 of one of the pairs, via which half bridge circuit 30 is connected to the full bridge circuit 24.

In the first step of the method, voltage information is acquired, which relates to a value of the current direct voltage at voltage source 16. Furthermore, a piece of power information is acquired, which relates to a value of the power currently to be transferred to rotor-side transfer coil 18 by way of stator-side transfer coil 17. The piece of voltage information and the piece of power information are determined based on control commands generated by way of control device 14 for controlling the operation of electric machine 2. Additionally or alternatively, this information can also be acquired using sensors.

Based on the piece of voltage information and the piece of power information, is determined in the next step of the method whether inverter circuit 13 should be operated in a half bridge operating mode or a full bridge operating mode. For this purpose, values for an expected efficiency regarding the inversion by way of inverter circuit 13 and the power transfer by way of rotary transformer 19 are determined. These values are then compared, wherein inverter circuit 13 is operated in the operating mode with the higher expected efficiency.

The specific procedure for comparing the efficiency values in this regard is explained below. Here, two characteristic curves 35, 36 are known, which indicate the function of the expected efficiency on the voltage value and the power value, i.e., on the piece of voltage information and the piece of power information, for each of the two operating modes. In the present case, characteristic curves 35, 36 each form a three-dimensional data set. Known characteristic curves 35, 36 are stored in the form of a lookup table 34 on control device 14 and were determined in the context of measurements and/or calculations and/or modeling. In the present case, it is assumed that the piece of voltage information indicates a current voltage value of 920 V at voltage source 16. FIG. 4 shows a coordinate system relating to a section through the two characteristic curves 35, 36 for the constant voltage value of 920 V. The section through these characteristic curves 35, 36 thus results in two characteristic lines, wherein the characteristic line resulting from characteristic curve 35 is associated with the full bridge operating mode and the characteristic line resulting from characteristic curve 36 is associated with the half bridge operating mode.

The coordinate system of FIG. 5 comprises an abscissa axis 37 relating to the power value and an ordinate axis 38 relating to the efficiency value, wherein the characteristic lines intersect at a specific power value, which is referred to below as power limit value 39. Below power limit value 39, the efficiency value is higher in the half bridge operating mode than in the full bridge operating mode. Above power limit value 39, the efficiency value is higher in the full bridge operating mode than in the half bridge operating mode. It should be noted that the procedure just explained regarding the section of characteristic curves 35, 36 can equally be carried out with respect to a constant value of the piece of voltage information, in which case a corresponding voltage limit value is obtained analogously. In this case, instead of the power, ordinate axis 37 concerns the value of the voltage instead.

By way of control device 14, the control signals or gate voltages are then generated and output to inverter circuit 13 or transistors 25 - 28, 31, 32 in such a way that inverter circuit 13 is in the half bridge operating mode when the piece of power information indicates that the power currently to be transferred is lower than power limit value 39, and that inverter circuit 13 is in the full bridge operating mode when the piece of power information indicates that the power currently to be transferred is greater than power limit value 39.

Reference is made below to FIGS. 3 and 4, wherein FIG. 3 shows a circuit diagram of inverter circuit 13 in the full bridge operating mode and FIG. 4 shows a circuit diagram of inverter circuit 13 in the half bridge operating mode. In the full bridge operating mode, the control signals are generated by way of control device 14 in such a way that the two half bridge transistors 31, 32 are permanently in a blocking operating state and thus form high resistances 40 that do not allow any current to flow through half bridge transistors 31, 32. With regard to the four full bridge transistors 25-29, the control signals are generated in such a way that they are permanently in a conducting state, apart from blocking states required in the context of inverting. Thus, in the full bridge operating mode, the direct voltage present on the part of voltage source 16, is completely converted by way of inverter circuit 13 into an alternating voltage which is to be supplied back to stator-side transfer coil 17.

In the half bridge operating mode, the control signals are generated by control device 14 in such a way that the two half bridge transistors 31, 32 are permanently in a conducting operating state, that the two full bridge transistors 25, 26, between which half bridge node 33 is arranged, are permanently in a blocking operating state and thus form high resistances 40 that do not allow any current to flow through full bridge transistors 25, 26. With respect to the other two full bridge transistors 27, 28, the control signals are generated in such a way that they are permanently in a conducting state, apart from blocking states required in the context of inverting. As can be seen, inverting in the half bridge operating mode takes place in such a way that the direct voltage present on the part of voltage source 16, is only partially converted, namely in this case half, by way of inverter circuit 13 into an alternating voltage which is to be supplied back to stator-side transfer coil 17.

German patent application no. 102024124736.3, filed August 29, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating an electric machine of a motor vehicle, wherein the electric machine includes a stator and a rotor rotatably mounted with respect to the stator and having rotor windings that generate a rotor magnetic field, wherein an inverter circuit that is provided on the stator converts a direct voltage of a voltage source into an alternating voltage that is output to at least one stator-side transfer coil, wherein power is transferred inductively to the rotor by way of the at least one stator-side transfer coil and energizes the rotor windings, wherein the inverter circuit includes a full bridge circuit which is connected to the voltage source via a half bridge circuit and is connected to the at least one stator-side transfer coil, the method comprising:
generating, by a control device, control signals that control transistors of the half bridge circuit and the full bridge circuit; and
outputting, by the control device, the control signals to the transistors of the half bridge circuit and the full bridge circuit,
wherein the control signals cause the inverter circuit to operate in a full bridge operating mode in which the direct voltage of the voltage source is completely converted into the alternating voltage by way of the inverter circuit, and
wherein the control signals cause the inverter circuit to operate in a half bridge operating mode in which the direct voltage of the voltage source is only partially converted into the alternating voltage by way of the inverter circuit.

2. The method according to claim 1, wherein the transistors of the full bridge circuit include two parallel-connected pairs of series-connected full bridge transistors, wherein a coil node is arranged between the full bridge transistors of each of the pairs, and wherein the at least one stator-side transfer coil is connected between the coil node arranged between the full bridge transistors of each of the pairs.

3. The method according to claim 2, wherein the transistors of the half bridge circuit include two series-connected half bridge transistors, wherein a half bridge node is arranged between the full bridge transistors of one of the pairs, via which the half bridge node the half bridge circuit is coupled to the full bridge circuit.

4. The method according to claim 3, wherein, while the inverter circuit is operated in the half bridge operating mode, the control signals control the half bridge transistors to be in a conducting state, and control the full bridge transistors, between which the half bridge node is arranged, to be in a non-conducting state.

5. The method according to claim 3, wherein, while the inverter circuit is operated in the full bridge operating mode, the control signals control the half bridge transistors to be in a non-conducting state.

6. The method according to claim 1, wherein, the control device generates the control signals based on a piece of power information relating to a power currently to be transferred to the rotor by way of the stator-side transfer coil and/or a piece of voltage information relating to a current direct voltage of the voltage source, and wherein the inverter circuit is either operated in the half bridge operating mode or in the full bridge operating mode.

7. The method according to claim 6,
wherein the control signals cause the inverter circuit to be operated in the half bridge operating mode when the piece of power information indicates that the power currently to be transferred is lower than a power limit value, and cause the inverter circuit to be operated in the full bridge operating mode when the piece of power information indicates that the power currently to be transferred is greater than the power limit value, and/or
wherein the control signals cause the inverter circuit to be operated in the half bridge operating mode when the voltage information indicates that a currently present direct voltage is lower than a voltage limit value, and cause the inverter circuit to be operated in the full bridge operating mode when the voltage information indicates that the currently present direct voltage is greater than the voltage limit value.

8. The method according to claim 7,
wherein a characteristic curve relating to efficiency of the inverter circuit and/or relating to efficiency of power transfer from the stator to the rotor as a function of currently transferred power is used both for operating the inverter circuit in the half bridge operating mode and for operating the inverter circuit in the full bridge operating mode, and wherein a value of the currently transferred power at which these characteristic curves intersect is used as the power limit value, and/or
wherein the characteristic curve relating to the efficiency of the inverter circuit and/or relating to the efficiency of the power transfer from the stator to the rotor as a function of the currently present direct voltage is used both for operating the inverter circuit in the half bridge operating mode and for operating the inverter circuit in the full bridge operating mode, wherein the value of the currently present direct voltage at which these characteristic curves intersect, is used as the voltage limit value.

9. A control device for operating an electric machine of a motor vehicle, wherein the electric machine includes a stator and a rotor rotatably mounted with respect to the stator and having rotor windings that generate a rotor magnetic field, wherein an inverter circuit that is provided on the stator converts a direct voltage of a voltage source into an alternating voltage that is output to at least one stator-side transfer coil, wherein power is transferred inductively to the rotor by way of the at least one stator-side transfer coil and energizes the rotor windings, wherein the inverter circuit includes a full bridge circuit which is connected to the voltage source via a half bridge circuit and is connected to the at least one stator-side transfer coil, the control device comprising:
a processor; and
a storage medium storing instructions that, when executed by processor, cause the control device to:
generate control signals that control transistors of the half bridge circuit and the full bridge circuit; and
output the control signals to the transistors of the half bridge circuit and the full bridge circuit,
wherein the control signals cause the inverter circuit to operate in a full bridge operating mode in which the direct voltage of the voltage source is completely converted into the alternating voltage by way of the inverter circuit, and
wherein the control signals cause the inverter circuit to operate in a half bridge operating mode in which the direct voltage of the voltage source is only partially converted into the alternating voltage by way of the inverter circuit.

10. An inverter circuit that converts a direct voltage of a voltage source into an alternating voltage and outputs the alternating voltage to at least one stator-side transfer coil, the inverter circuit comprising:
a half bridge circuit; and
a full bridge circuit which is or can be connected to the voltage source via the half bridge circuit and is or can be connected to the at least one stator-side transfer coil,
wherein the inverter circuit, in operation, receives control signals from a control device,
wherein the control signals cause the inverter circuit to operate in a full bridge operating mode in which the direct voltage of the voltage source is completely converted into the alternating voltage by way of the inverter circuit, and
wherein the control signals cause the inverter circuit to operate in a half bridge operating mode in which the direct voltage of the voltage source is only partially converted into the alternating voltage by way of the inverter circuit.

11. A stator for an electric machine for a motor vehicle, comprising:
an inverter circuit according to claim 10.

12. An electric machine for a motor vehicle, comprising:
the stator according to claim 11; and
a rotor rotatably mounted with respect to the stator and having rotor windings that, in operation, generate a rotor magnetic field.

13. The electric machine according to claim 12, further comprising:
an inductive rotary transformer that includes:
at least one rotor-side transfer coil present on the rotor; and
the at least one stator-side transfer coil present on the stator,
wherein, in operation, power is inductively transferred to the at least one rotor-side transfer coil by way of the at least one stator-side transfer coil and energizes the rotor windings.

14. The electric machine according to claim 13, wherein the at least one rotor-side transfer coil is connected to the rotor windings via a rectifier circuit, and wherein, by way of the rectifier circuit, the alternating voltage present on the at least one rotor-side transfer coil is converted into a direct voltage that generates the rotor magnetic field.

15. A motor vehicle comprising:
a traction motor, wherein the traction motor is the electric machine according to claim 12.
